(19) United States
(12) Patent Application Publication
(10) Pub. No.: US 2004/0012802 A1
(43) Pub. Date: Jan. 22, 2004

(54) System and method for printing a data file

(76) Inventors: Kram H. Allen, Meridian, ID (US); Linn J. Kropf, Boise, ID (US); Clifford L. Coppinger, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/198,484

(22) Filed: Jul. 17, 2002

(51) Int. Cl. B41F 1/00; G06F 15/00

(52) U.S. Cl. 358/1.13; 358/1.15

(57) ABSTRACT

A printing system is provided that allows a user to reprint a previously printed data file. The system includes a printer driver configured to enable printing of the data files. A list of printed data files is stored by the printer driver. A user interface is configured to display the list of printed data files and to allow a user to select a data file to be reprinted. A reprinting module is also included to reprint the selected data file through the printer driver.

### FIELD OF THE INVENTION

The present invention relates to printing of data files.

### BACKGROUND

Computer systems and their accompanying software programs allow users to create documents, spreadsheets, images, and a multitude of other files. Once a file is created by a computer program or an application, the file can be closed and then accessed or modified in the future. Users are later able to modify or add material to the file by reopening the file. When a user desires to access data files previously used with a specific application or program, the user first opens the application that created the document. Then the user opens the file from the file open dialog box in the application or the user accesses a list of previously opened files. The list of previously opened files is often at the bottom of a file menu listing and this list generally displays which files have recently been opened in the computer application. Often, this list is prioritized based on the most recently opened document.

For example, if a user has been utilizing a word processing application and has opened a specific document, then the file may be listed in the most recently used list in the program's file menu. This way the user can immediately select the file they want to open without searching through the operating system's hierarchical file system. Once the user has opened the document, the user is able to perform the necessary functions on the document such as modifying or adding to the document.

Some operating systems such as the Windows operating system from Microsoft provide a list of most recently used documents regardless of which application has opened the file. This list contains about 15 of the most recently opened documents. Since this list applies to every application, a document or file that needs to be reopened may not be listed if the user has opened more than two or three documents in several applications.

### SUMMARY OF THE INVENTION

The invention provides a printing system that allows a user to reprint a previously printed data file. The system includes a printer driver configured to enable printing of the data files. A list of printed data files is stored by the printer driver. A user interface is configured to display the list of printed data files and to allow a user to select a data file to be reprinted. A reprinting module is also included to reprint the selected data file through the printer driver.

### BRIEF DESCRIPTION OF THE DRAWINGS

FIG. 1 illustrates a graphical computer desktop with printer icons that enables a user to reprint data files through a desktop icon or an activity tray icon in accordance with an embodiment of the present invention;

FIG. 2 depicts an embodiment of the invention with a printer window in an operating system that allows a user to access a list of printed data files;

FIG. 3 illustrates an open application on the desktop that allows a user to reprint previously printed data files in accordance with an embodiment of the present invention; and

FIG. 4 is a block diagram illustrating an embodiment of a printing system of the present invention that allows a user to reprint a previously printed data file;

FIG. 5 is a flowchart illustrating one embodiment of a method for reprinting a previously printed data file.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

After a user has closed a file and the associated application through which the file was created or accessed, then the user opens the application or program again when the user wants to perform further functions upon the file. This is a problem because sometimes a user has printed a document and then the user has closed the application. Later the user may receive a request from a coworker or customer to reprint the file, or the user may need extra copies of the file for a presentation, etc. Presently, there is no way to quickly reprint the document without reopening the application.

The requirement of opening an application before reprinting a document can be a problem from a number of perspectives. The first issue is that it is time consuming to restart and then close an application just because a single data file or document needs to be printed. It takes much longer to open and close the specific application than it does to actually print a data file once the application is finally open.

Another problem is that the user may not be able to remember where the previously printed document is located in the computer's file system. If the document the user is searching for is one of the last few documents opened in the application, then the file will appear in the recently opened list in the application's menus. This makes the document easier to find and open. On the other hand, if the document is not one of the recently opened documents, then it will not be accessible through the file menu listings. In this case, the user spends a measurable amount of time to navigate to the location where the file is located. If the user does not remember where the file is, they can spend even more time looking for the file.

Opening an application or program just to print a data file that has already been printed creates the additional problem that operating system resources are consumed when the program is loaded. Since the user is often running a multitude of other applications, opening yet another application can slow down the operating system just to reprint a data file. Opening an application just to print can also create other problems if the application is badly behaved. This is because the application will not release its resources properly or it may leave dead processes behind when it closes. Some operating systems can correct the problems left behind by a badly behaved process but it takes time and slows down the operating system.

As mentioned, some existing operating systems (such as the Microsoft Windows operating system) provide a list of recently opened documents regardless of which application has opened the file. This recently opened document list allows a user to select the option of reprinting a document, but to do this the operating system will open the application associated with the selected file and automatically execute the print command from within the application. Then the system will automatically close the application that was used to perform the printing. Unfortunately, this involves loading the application associated with the selected data file into memory for a single command and then unloading it from memory after that single command is completed. Loading an application associated with a file is a problem because a limited amount of computer system resources are available and opening the application wastes time.

Another problem with the most recently opened file approach in the operating system is that it cannot be assumed that recently opened files have been recently printed. A user may have just opened 20 files without printing and so the most recently printed file may not be displayed in the list of recently opened files. Thus, a most recently opened list is not particularly related to which data files have been most recently printed. A system that relies on tracking the most recently opened files assumes that the user is able to find the file they are looking for in the list of most recently opened files, which is probably not the case with printing.

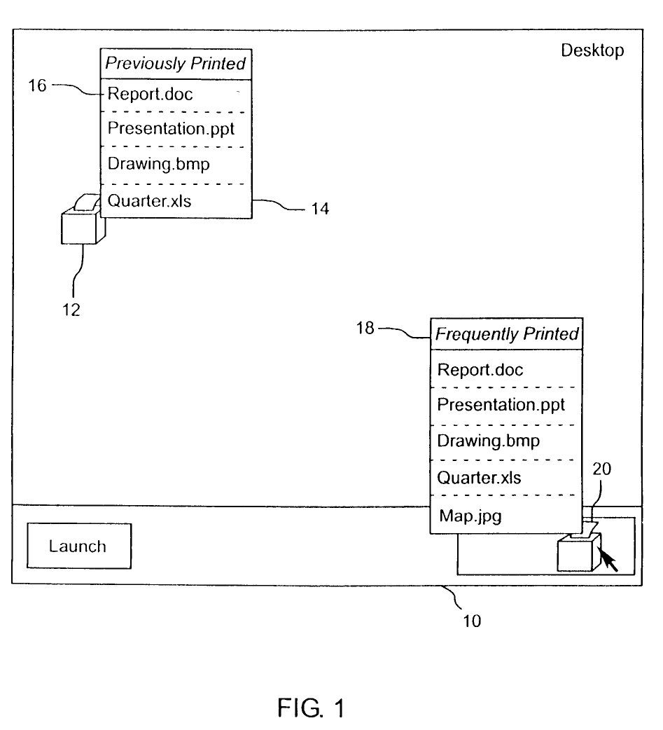

The system and method of the present invention aid in solving the problems discussed above by providing a printing system that allows a user to reprint a previously printed data file in an efficient manner. Specifically in FIG. 1, a graphical desktop is illustrated 10 with a number of objects residing on that desktop. In one embodiment of the invention, a previously printed list 14 is accessed from an icon 12 located on the desktop. This previously printed list is in communication with a printer driver that has access to data files and enables a user to print the data files. Initially, the data files will be received by the printer driver as applications request or send print jobs that need to be printed. The printer driver interprets the information sent to it in the data file and converts this information to an electronic language that is understandable by the printer hardware.

As the printer driver of the present invention receives the data files and prints them, the printer driver builds a list of printed data files. The printer driver can store this list in a queue or database that is written to a mass storage device. For example, this list can be stored on the hard drive. Alternatively, the list can be stored in memory until the user shuts down their computer or workstation.

In order to allow the user to access the list of printed files, the printer driver includes a user interface that is configured to display the list of printed data files 14. The user is also able to select a data file that is listed in the user interface in order to request that the file be reprinted.

In this embodiment of FIG. 1, a user could select the file “report.doc” 16 to be reprinted. Once the file name has been selected, it will be used by a reprinting module to identify the selected data file to reprint through the printer driver. The reprinting module can be implemented as part of the printer driver or it may be separate software module that interacts with the printer driver. The reprinting of the file takes place without using the application through which the data file was originally created. Accordingly, the operating system is able to avoid starting or loading a word processing program with which “report.doc” was created. This saves the user time and frees up computer system resources that would otherwise be needed to open the application.

There are a number of ways to implement this system and method for reprinting previously printed documents. One embodiment of the invention can store a file that includes the formatting commands and data sent from the application when the file is printed the first time. For example, when a program prints to a Post Script printer driver, various commands are sent for formatting of text and organizing images. Additional information that can be stored for each data file are the printer settings, printer configurations, and system printing options. This file is then translated by the printer driver into hardware control codes that can be interpreted by a printer. This file of printer control codes is sent to a printer queue on the local machine or on a network, and then the file is sent to the printer for physical printing. The printer driver can store a data file that will contain formatting commands and data for the printer driver or translated control codes. In other words, a printer ready file or a similarly encoded file can be stored so that it can be reused. Saving the printer codes avoids reinterpreting the commands from the application when the reprint is requested.

The present invention for reprinting previously printed data files is also significantly different than networked print queues that have allowed a user to reprint a document through the print queue. One problem with a network print queue that can store most recently printed documents is users are not able to access the printer queue directly from the desktop or through the printer driver. Typically, for someone to access the network printer queue the user needs to have nearly as much knowledge about the computer network as the network administrator.

Even if the user is able to execute the complex list of commands that allows the user to access the printer spool containing a list of printed files, then the user will have to find the file they would like to reprint. In most cases, ten, twenty, or even a hundred users can be connected to a single network printer. As a result, there can be hundreds, if not thousands of documents sent to the printer every day. This makes it a difficult task for the user to find one of their own files they want to reprint.

The present invention is also different from a network printer queue because it provides local information for print files that have been previously printed. This local information for printed files is easily accessible to the user from their own desktop without any special commands, network organization, or additional network software that must be loaded.

As discussed, the printer driver includes a list of printed data files. This list can be organized in any number of arrangements that are relevant to the user. One organization of these files is displaying the recently printed files and ordering the files by displaying the most recently printed file first. Another configuration that can be used is displaying the list in the order of the most frequently printed files. This is a useful configuration because many users print the same file repeatedly. As an example, an accountant may print a weekly summary from the same spreadsheet. Thus, instead of seeing the most recently printed files, the user would rather see the most frequently printed files 18, as in FIG. 1, because the user wants to keep reprinting the same files. Other priority or weighting based methods for organizing the previously printed files can also be provided by one skilled in the art.

An example of a situation where a most recently printed function can be of value is when a user has recently printed a document and then another individual asks the user for a copy of the document they have recently printed. The present invention frees the user from reopening the associated application or from spending time to remember where the file is located which needs to be reprinted.

As discussed previously, the listing of printed data files can be accessed by the user through a printer driver icon. One convenient location for a printer driver icon is on the user's desktop 12. FIG. 1 illustrates that the activity tray 20 (or taskbar tray) is another convenient place for a printer driver icon to be displayed. In both situations, the list of printed data files can be accessed by passing or rolling the pointer icon (e.g. a mouse) over the printer icon and this will bring up the list. An alternative method allows the user to right or left click on the printer driver icon to display the list of printed data files. The list that is displayed can be in popup menu format, on a floating scrollable window, or an independent window may display the list. When the list is displayed, the user can select one or more data files from the popup list to be reprinted.

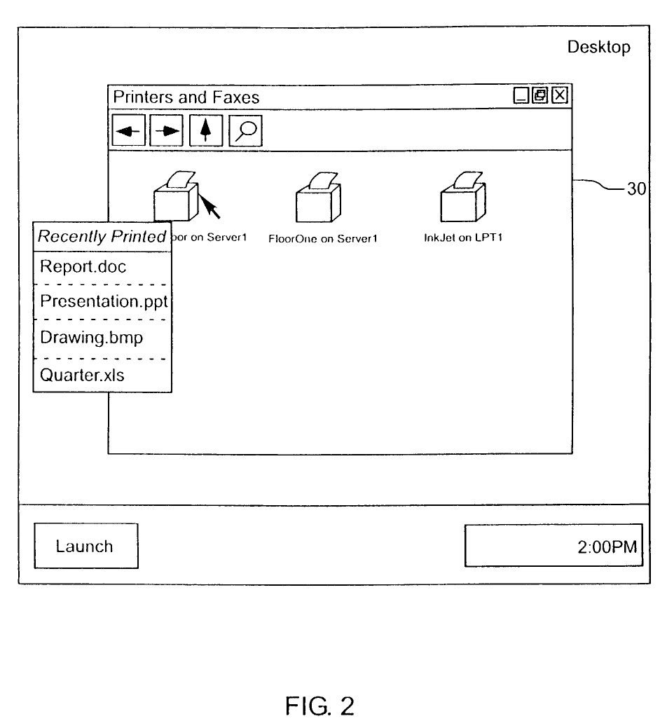

FIG. 2 illustrates another location where the list of printed files can be displayed. This figure illustrates that the list of printed files can be accessed from the printer installation and configuration window 30. When the user opens this window they can direct their pointer icon to rest over a printer driver icon and then a list of the previously printed files will appear. This can also be done by selecting and activating the icon, or by opening a popup menu with a right or left click to display the previously printed files.

Another interface location where the list of printed files can be displayed is on a tab of the printer driver window (not shown). A scroll box, drop-down list, or a similar graphical control can be placed on a printer driver properties tab. This graphical control can then be accessed by the user to pick one or more files that should be reprinted. Since the printer driver window that includes a printer's properties window is buried within the operating system, an icon with a direct link to the window or tab can be placed directly on the user's desktop to make the feature more accessible. This way the user can avoid hunting through a myriad of windows or locations to find the correct printer tab in this alternative embodiment. Moreover, the printer driver icon and/or list of previously printed files can be located in any number of convenient places within the user interface for the operating system. For example, the access can be available through an activity tray, application menu, operating system utility menu, or a program launch menu.

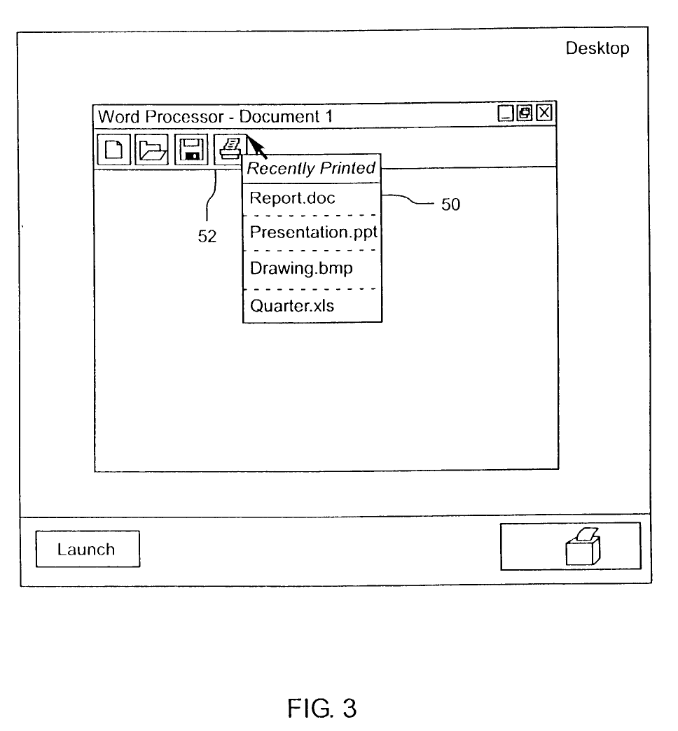

FIG. 3 illustrates an embodiment of the invention where the list of printed data files can also be displayed from within an application. The application menu 52 can include a printer icon or a printer driver icon. This way the list of printed files is displayed in a popup menu when the pointer icon crosses over the printer driver icon or the icon is clicked. The user is then able to select a file or files to have reprinted from the popup menu 50. Accordingly, the reprinting of the previously printed files can circumvent the application's need to send the file to the printer driver and the printing will be performed just through the printer driver, which makes a reprint faster than the original print job.

This added application functionality is also valuable because it allows a user to print a previously printed data file from any application regardless of which application the user is currently using. In the past, opening a recently opened file in an application was tied to the application from which the function was requested. The present invention enables a user to reprint a previously printed file for any application from one application, without opening each application. For example, a user may reprint a spreadsheet document from a word processing application. This provides valuable functionality and can save the user a significant amount of time.

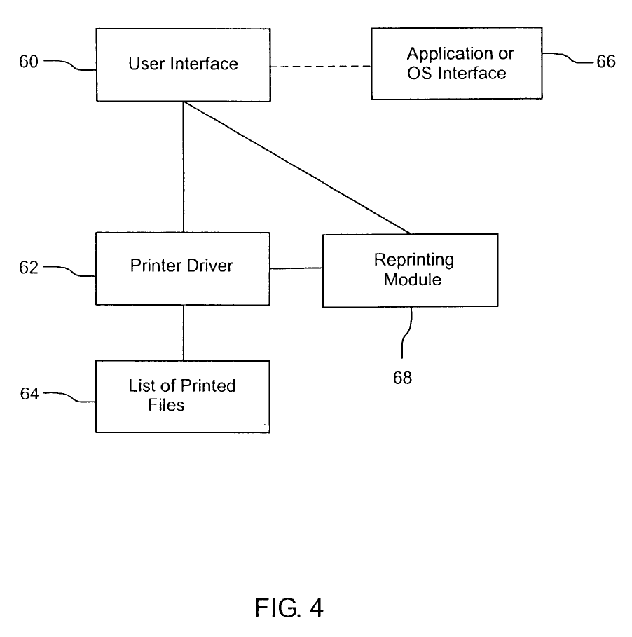

FIG. 4 is a block diagram illustrating one embodiment of a printing system that allows a user to reprint a previously printed data file. The printing system includes a printer driver 62 configured to enable printing of data files. A list of printed data files 64 is stored by the printer driver. As discussed, this list may be stored in any usable digital format. The list can be stored on the local computer but it may be stored in a networked location. The printing system and printer driver are located on and execute on a user's local computer. A user interface 60 is configured to display the list of printed data files and to allow a user to identify a selected data file to be reprinted and a reprinting module 68 is used to reprint the selected data file through the printer driver. The user interface can be associated with the operating system user interface or associated with the application user interface 66.

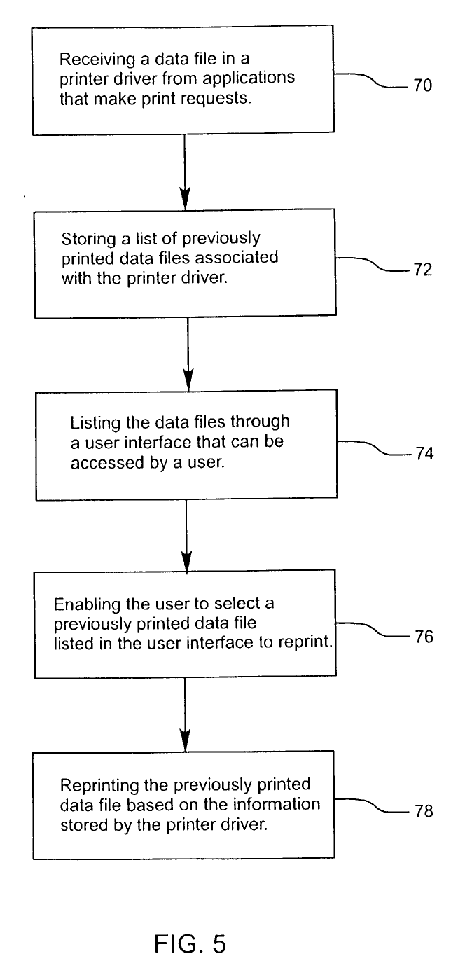

FIG. 5 is a flowchart illustrating operations for reprinting a previously printed data file. The method includes the operation of receiving a data file into a printer driver from applications that make print requests at block 70. This will typically occur when a user requests that an application print a data file or document. Another operation is storing a list of previously printed data files associated with the printer driver at block 72. The list of previously printed data files is based on the data files received by the printer driver. The printer driver can build a database that includes the data files that have already been printed. This database may be a sequential flat file with specific file printing attributes associated with each entry or the database can be a more complex data structure.

A further operation of this method is listing the data files through a user interface that can be accessed by a user at block 74. This listing operation will generally be implemented through providing a popup menu, a separate mini-window, or through some similar graphical interface means. Then the user will be able to select one of the previously printed data files listed in the user interface to reprint at block 76. As a result of the user's selection, the previously printed data file will be reprinted based on information stored by the printer driver at block 78. This method allows the previously printed data file to be reprinted without loading the application with which the data file is associated. In addition, the user is able to avoid opening the data file into the associated application.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A printing system that allows a user to reprint a previously printed data file, comprising:
a printer driver configured to enable printing of data files;
a list of printed data files that is stored by the printer driver;
a user interface configured to display the list of printed data files and to allow a user to identify a selected data file to be reprinted; and
a reprinting module to reprint the selected data file through the printer driver.

2. A printing system as in claim 1, wherein the reprinting module reprints the selected data file without using an application through which the selected data file was originally created.

3. A printing system as in claim 1, wherein the reprinting module reprints the selected data file through the printer driver using printing settings and files stored in a printer driver queue.

4. A printing system as in claim 1, wherein the list of printed data files includes recently printed files.

5. A printing system as in claim 1, wherein the list of printed data files includes most frequently printed files.

6. A printing system as in claim 1, wherein the user interface further comprises a printer driver icon that can be accessed by a user.

7. A printing system as in claim 6, wherein the user interface further comprises a popup menu that is activated when the user moves a pointer icon over the printer driver icon.

8. A printing system as in claim 7, wherein the popup menu includes the list of recently printed data files and the user can select at least one data file from the popup menu to be reprinted.

9. A printing system as in claim 7, wherein the popup menu includes the list of frequently printed data files and the user can select at least one data file from the popup menu to be reprinted.

10. A printing system as in claim 6, wherein the printer driver icon that is located in a user interface location is selected from the user locations consisting of an operating system desktop, an activity tray, application menu, operating system utility menu, or a program launch menu.

11. A printing system as in claim 1, wherein the user interface displays the list of recently printed data files on a printer tab in a printer driver window.

12. A printing system as in claim 1, wherein the user interface is further configured to allow the user to reprint a previously printed file from within a first application for other applications.

13. A method for reprinting a previously printed data file, comprising the steps of:
storing a list of previously printed data files associated with a printer driver, and the list of previously printed data files is based on data files received by the printer driver;
listing the previously printed data files through a user interface that can be accessed by a user;
enabling the user to select at least one of the previously printed data files listed in the user interface to reprint; and
reprinting the previously printed data file based on information stored by the printer driver.

14. A method as in claim 13, wherein the step of reprinting the previously printed data file further comprises the step of reprinting the previously printed data file without loading the application with which the previously printed data file is associated.

15. A method as in claim 14, further comprising the step of reprinting the previously printed data file without opening the previously printed data file into the previously printed data file's associated application.

16. The method as in claim 13, wherein the step of storing a list of previously printed data files further comprises the step of storing file information and printer settings associated with a print job.

17. The method as in claim 13, wherein the step of enabling the user to select one of the previously printed data files to reprint, further comprises the step of enabling the user to select a most recently printed data file from a list that is prioritized by the most recently printed data file.

18. The method as in claim 13, wherein the step of enabling the user to select one of the previously printed data files to reprint, further comprises the step of enabling the user to select a previously printed data file from a list that is prioritized based on which data files are printed the most frequently.

19. The method as in claim 13, wherein the step of enabling the user to select one of the previously printed data files to reprint, further comprises the step of allowing the user to select previously printed data files to reprint from a popup menu that is associated with a printer driver icon.

20. The method as in claim 13, wherein the step of enabling the user to select one of the previously printed data files to reprint, further comprises the step of allowing the user to select previously printed data files to reprint from a popup menu that is associated with user interface locations selected from the user interface locations consisting of an operating system desktop, an activity tray, application menu, operating system utility menu, and a program launch menu.

21. The method as in claim 13, further comprising the step of receiving data files into a printer driver from applications that make print requests.

22. The method as in claim 13, wherein the step of reprinting the previously printed data file further comprising the step of reprinting the previously printed data file using a printer ready file that is stored by the printer driver.

23. A method for printing a recently printed data file by directly accessing a printer driver, comprising the steps of:
receiving data file information in the printer driver from applications that make print requests;
storing the data file printing information, including the printing location and settings;
organizing a list of previously printed data files;
listing the previously printed data files through a user interface that can be accessed by a user;
allowing the user to select a previously printed data file to reprint;
reprinting the previously printed data file without opening the application through which the application was originally created and printed.

24. A method as in claim 23, further comprising the step of listing the previously printed files in the order of most recently printed files.

25. A printing system that allows a user to reprint a previously printed data file, comprising:
a printer driver means for accessing data files and for enabling printing of the data files;
a printed data file listing means for listing printed data files, which is coupled to the printer driver;
a user interface means for displaying the list of printed data files and for allowing a user to identify a selected data file to be reprinted; and
a reprinting means for reprinting the selected data file through the printer driver means.

26. An article of manufacture, comprising:
a computer usable medium having computer readable program code embodied therein for reprinting a previously printed data file, the computer readable program code in the article of manufacture comprising:
computer readable program code for storing a list of previously printed data files associated with the printer driver, and the list of previously printed data files is based on the data files received by the printer driver;
computer readable program code for listing the data files through a user interface that can be accessed by a user;
computer readable program code for enabling the user to select at least one of the previously printed data files listed in the user interface to reprint; and
computer readable program code for reprinting the previously printed data file based on the information stored by the printer driver.
